(19) United States
(12) Patent Application Publication
(10) Pub. No.: US 2012/0210597 A1
(43) Pub. Date: Aug. 23, 2012

(54) Heat Pump Laundry Dryer and a Method for Operating a Heat Pump Laundry Dryer

(75) Inventors: Alberto BISON, Pordenone (IT); Francesco CAVARRETTA, Pordenone (IT)

(73) Assignee: ELECTROLUX HOME PRODUCTS CORPORATION N.V., Brussel (BE)

(21) Appl. No.: 13/398,161

(22) Filed: Feb. 16, 2012

(30) Foreign Application Priority Data
Feb. 18, 2011 (EP) 11155063.8

(51) Int. Cl. F26B 21/00; F26B 3/02

(52) U.S. Cl. 34/524; 34/86; 34/513

(57) ABSTRACT

A heat pump system of a laundry dryer comprises a closed refrigerant circuit (10) and a drying air circuit (12). The refrigerant circuit (10) includes a compressor (14), a condenser (16), an expansion device (18) and a main evaporator (20). The air stream circuit includes the main evaporator (20), the condenser (16), a laundry drum and at least one fan (26). The refrigerant circuit (10) and the air stream circuit are thermally coupled by the condenser (16) and the main evaporator (20). The condenser (18) is a heat exchanger provided for heating up the air stream and cooling down the refrigerant. The main evaporator (20) is a heat exchanger provided for cooling down the air stream and heating up the refrigerant. At least one additional evaporator (22) is arranged in parallel to the main evaporator (20), and is switchably connected to the refrigerant circuit (10).

### CROSS-REFERENCE TO RELATED APPLICATION

This application claims priority to European Application No. 11155063.8, filed Feb. 18, 2011.

### BACKGROUND OF THE INVENTION

The present invention relates to a laundry dryer with a heat pump system. Further, the present invention relates to a method for operating a laundry dryer with a heat pump system.

In laundry dryers, heat pump technology is the most efficient way to save energy during drying laundry. In conventional heat pump laundry dryers, a drying air stream flows in a closed loop. The drying air stream is moved by a fan, passes a laundry drum and removes water from wet clothes. Then the drying air stream is cooled down and dehumidified in a heat pump evaporator, heated up in a heat pump condenser and directed again into the laundry drum.

A refrigerant is compressed by a compressor, condensed in the condenser, expanded in an expansion device and then vaporized in the evaporator. Therefore, the temperatures of the drying air stream and a refrigerant are correlated to each other.

The operation cycle of the heat pump laundry dryer includes two phases, namely a transitory phase (or warm-up phase), and a steady state phase. During the transitory phase the temperatures of the drying air stream and the heat pump system, which are usually at the ambient temperature when the tumble dryer starts to operate, increase up to desired levels. During the steady state phase, the temperatures of the drying air stream remain substantially constant and also the temperatures of the heat pump system are kept quite constant, for example by means of a compressor cooling fan or an auxiliary condenser, until the laundry is dried.

At the beginning of the cycle, the drying rate is very low. The air stream needs time to reach an appropriate temperature for removing water from the laundry and for being dehumidified in the evaporator of heat pump system. The heat pump system needs hot and cold heat sinks due to its intrinsic functionality. However, during the transitory phase, in particular during the first part of transitory phase, the heat pump system cools down the air stream without dehumidifying said air stream since, substantially, no water is removed from the clothes. Thus, the cooling capacity is useless for the drying process. Further, the condenser must heat up again the drying air stream after being cooled down unnecessarily.

FIG. 3 shows a schematic diagram of the temperatures T of the air stream at some checkpoints of a conventional heat pump system for the tumble dryer as a function of time t. In FIG. 3 the temperature T_{cond,out} of the air stream at the output of the condenser, the temperature T_{drum,out} of the air stream at the output of the laundry drum and the temperature T_{evap,out} of the air stream at the output of the evaporator are shown. Further, the ambient temperature T_{amb} is shown. FIG. 3 clarifies the behaviour of said temperatures during the transitory phase and the steady state phase.

### SUMMARY OF SELECTED INVENTIVE ASPECTS

It is an object of the present invention to provide a heat pump system for a tumble dryer, which overcomes problems as mentioned above.

According to an aspect of the present invention, the refrigerant circuit of a heat pump system for a tumble dryer includes at least one additional evaporator arranged parallel to the main evaporator, wherein the additional evaporator is switchably interconnected within the refrigerant circuit via valve means, so that the refrigerant passes through either the main evaporator or the additional evaporator.

In an embodiment of the present invention, the refrigerant circuit includes at least one additional evaporator and valve means to selectively switch the refrigerant circuit between a first mode in which the refrigerant by-passes the main evaporator and flows through the additional evaporator, and a second mode in which the refrigerant by-passes the additional evaporator and flows through the main evaporator.

The additional evaporator allows heating up the refrigerant without unnecessarily cooling down the drying air. Thus, the temperature of the drying air increases faster and the transitory phase is shortened.

Preferably, the additional evaporator is switchably connected to the refrigerant circuit via at least two three-way valves or at least two pairs of on-off valves.

Preferably, the additional evaporator is a heat exchanger, arranged outside the drying air circuit so that the drying air circuit and the additional evaporator are not thermally coupled.

In an alternative embodiment, the additional evaporator is a heat exchanger that can be thermally coupled to the drying air circuit at least during one operational stage of the laundry dryer so that the drying air can exchange heat with the additional evaporator during said operational stage.

During said operational stage, the refrigerant flows through the main evaporator and the additional evaporator pre-cools the drying air before entering the main evaporator.

The additional evaporator is a heat exchanger and preferably at least a part of said additional evaporator can be embedded in phase changes materials, wherein the additional evaporator and the air stream circuit can be thermally coupled.

Preferably, the phase changing temperatures of the phase changes materials are between 10° C. and 30° C.

Further, the drying air circuit may comprise at least one baffle device, so that the drying air stream either flows through the additional evaporator or bypasses the additional evaporator.

In particular, the air stream circuit comprises at least one first baffle device connected to the inlet of the additional evaporator and at least one second baffle device connected to the outlet of the additional evaporator.

The object of the present invention is further achieved by the method for operating a heat pump system.

According to a method aspect of the present invention, it is possible to selectively switch the refrigerant circuit between a first mode in which the refrigerant by-passes the main evaporator and flows through the additional evaporator, and a second mode in which the refrigerant by-passes the additional evaporator and flows through the main evaporator.

Preferably, the first mode occurs during a first operational stage of the laundry dryer starting when the compressor is switched on. Since the refrigerant is heated up without cooling down the air stream, the temperature of the air stream increases faster and the transitory phase is shortened.

For example, during the transitory phase of the operating cycle the refrigerant is heated up in the additional evaporator by ambient air. Preferably, during the transitory phase of the operating cycle the refrigerant is heated up in the additional evaporator by phase changes materials in which the additional evaporator is at least partially embedded.

### BRIEF DESCRIPTION OF THE DRAWINGS

The invention will be described in further detail with reference to the drawings, in which:

FIG. 1 illustrates a schematic diagram of a heat pump system for a tumble dryer according to a first embodiment of the present invention;

FIG. 2 illustrates a schematic diagram of the heat pump system for the tumble dryer according to a second embodiment of the present invention; and

FIG. 3 illustrates a schematic diagram of temperatures at some checkpoints of a conventional heat pump system for the tumble dryer as a function of time.

### DETAILED DESCRIPTION OF EXAMPLE EMBODIMENTS

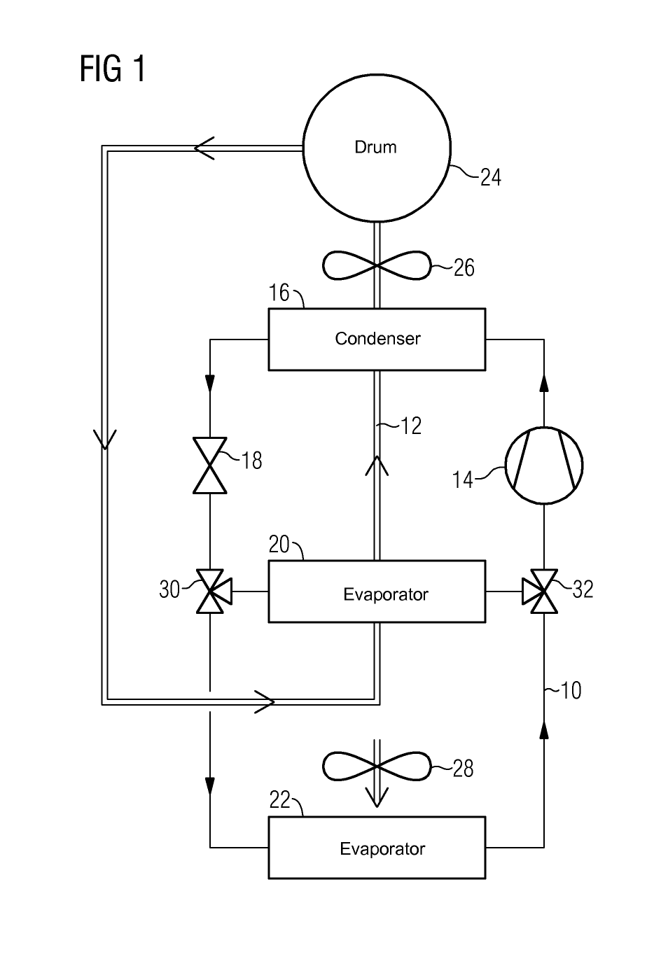

FIG. 1 illustrates a schematic diagram of a laundry dryer with a heat pump system according to a first embodiment of the present invention. The heat pump system includes a closed refrigerant circuit 10 and a drying air circuit 12, preferably, forming a closed loop circuit.

The drying air circuit 12 includes a laundry chamber 24, preferably a rotatable drum, a main evaporator 20, a condenser 16 and a fan 26. The condenser 16 and the main evaporator 20 are heat exchangers and form the thermal interconnections between the refrigerant circuit 10 and the drying air circuit 12.

The refrigerant circuit 10 includes a compressor 14, the condenser 16, an expansion device 18, the main evaporator 20, an additional evaporator 22 and an additional fan 28. The compressor 14, the condenser 16, the expansion device 18 and the main evaporator 20 are arranged in series and form a closed loop. The additional evaporator 22 is arranged parallel to the evaporator 20. Instead of the main evaporator 20, the additional evaporator 22 may be interconnected into the refrigerant circuit 10. An additional fan 28 corresponds with the additional evaporator 22. The additional evaporator 22 is a heat exchanger and forms a thermal interconnection between the refrigerant circuit 10 and the ambient air.

A first three-way valve 30 is interconnected between the outlet of the expansion device 18 and the inlets of the main evaporator 20 and the additional evaporator 22. A second three-way valve 32 is interconnected between the outlets of the main evaporator 20 and the additional evaporator 22 and the inlet of the compressor 14. Alternatively, instead of the three-way valves 30 and 32, respectively, a pair of on-off valves may be used in each case. Depending on the states of the three-way valves 30 and 32, either the main evaporator 20 or the additional evaporator 22 is interconnected within the refrigerant circuit 10.

In the drying air circuit 12, the main evaporator 20 cools down and dehumidifies the drying air coming from the laundry chamber 24. Then the condenser 16 heats up the air stream, before the drying air enters into the laundry chamber 24 again. The drying air is driven by the fan 26.

The operation cycle of the heat pump system is subdivided into a transitory phase and a steady state phase.

During the transitory phase the refrigerant flows through the additional evaporator 22. The additional evaporator 22 allows a heat exchange with ambient air. The refrigerant is vaporized in the additional evaporator 22, then sucked by the compressor 14 and condensed in the condenser 16. The additional fan 28 moves ambient air to the additional evaporator 22. Since the refrigerant does not flow through the main evaporator 20, the air stream is not cooled down and enters into the condenser 16 at a relative high temperature level. Therefore the present solution enables the drying air to be heated up in a more effective way during the transitory phase so that as a consequence the transitory phase becomes shortened. On the other side, without shortening the transitory phase, it is possible to reduce the heating power provided to the drying air by the condenser 16 during the transitory phase, since the present solution makes the difference between the temperatures of the refrigerant and drying air smaller that in conventional heat pump laundry dryer, since the drying air is not cooled down in the main evaporator when the refrigerant flows in the additional evaporator.

When the drying air at the outlet of the condenser 16 reaches favourable conditions, then the valves 30 and 32 are switched and the refrigerant flows through the main evaporator 20, so that the drying air is cooled down and dehumidified. The additional evaporator 22 stops working.

The activation of the main evaporator 20 can be decided in response to predetermined parameters. The parameters may be at least one of the temperatures of the drying air stream and/or the time progressions of said temperatures. Further, the parameters may be at least one temperature and/or pressure of the refrigerant and/or the time progressions of said temperatures. There are sensors arranged at the air stream circuit 12 and/or at the refrigerant circuit 10. Preferably the temperatures at the inlet and/or the outlet of the laundry chamber 24, the temperatures and/or pressures of the refrigerant at the inlets and/or outlets of the condenser 16 and/or the compressor 14 are useful parameters for actuating the valves 30 and 32, so that the refrigerant flows through the main evaporator 20.

Another criterion for activating the main evaporator 20 may be the actuating of the valves 30 and 32 after a predetermined time interval. Said time interval may be calculated on the basis of tests and experience.

A further option for activating the main evaporator 20 may be the amount of laundry loaded into the laundry drum 24. The weight of the laundry may be determined automatically by a sensor or input manually on a control panel by the user.

During the steady state phase, the refrigerant is compressed by the compressor 14, condensed in the condenser 16, expanded in the expansion means 18 and vaporized in the main of the refrigerant circuit 10.

The condenser 16 and the main evaporator 20 do not always condense and evaporate, respectively, the refrigerant. For example, if CO₂ is used as refrigerant and said refrigerant operates at the supercritical mode, i.e. at least at the critical pressure and therefore always in gas phase, then the refrigerant is neither condensed nor evaporated. In this case, the condenser 16 and the main evaporator 20 operate factually as a gas cooler and a gas heater, respectively.

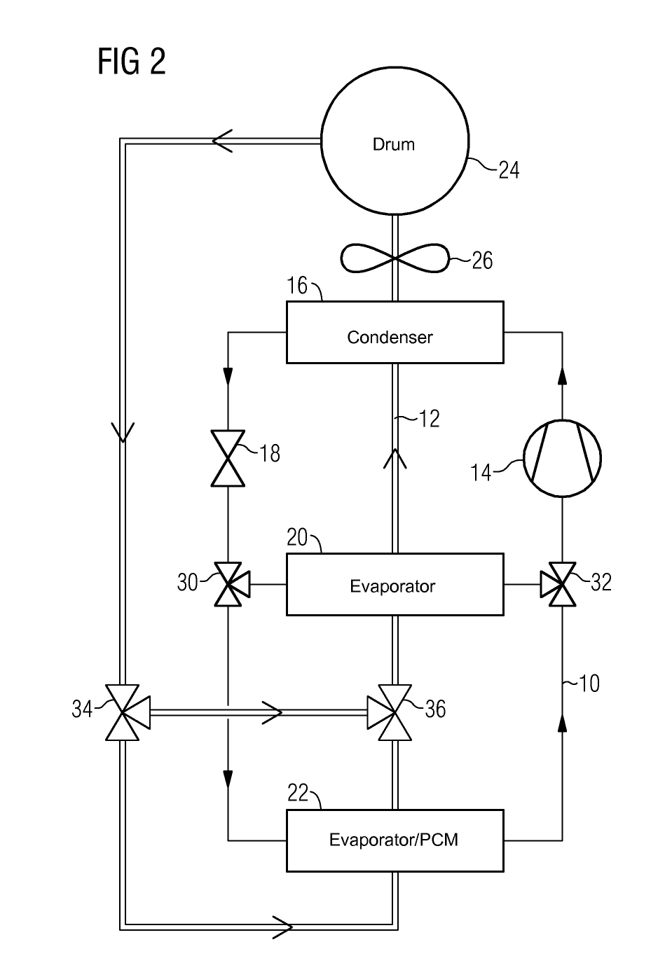

FIG. 2 shows a schematic diagram of a heat pump system for a tumble dryer according to a second embodiment of the present invention. The heat pump system of the second embodiment comprises the same components as the heat pump system of the first embodiment, except that it lacks the additional fan 28.

Further, the heat pump system of the second embodiment includes a first baffle device 34 and a second baffle device 36, so that the air stream flows either through the main evaporator 20 or through the additional evaporator 22. In the latter case, the additional evaporator 22 is a heat exchanger forming a thermal interconnection between the refrigerant circuit 10 and the air stream circuit 12.

In the second embodiment, phase change materials are used as a cold sink for the additional evaporator 22. At least a part of the refrigerant circuit is embedded in an assembly of known suitable phase change materials (PSMs). During the transitory phase, the phase change materials are used as a cooling source for the heat pump operation, wherein the drying air forms the heating source. The refrigerant cools down the phase change materials, which become solidified, wherein the refrigerant is heated up and vaporized. The phase change materials are set/selected to change phase at a convenient temperature, for example between 10° C. and 30° C. In this way, the drying air is not involved in a useless cooling process during the transitory phase, since the main evaporator 20 is bypassed by the refrigerant and the additional evaporator 22 is by-passed by the process air.

When a favourable temperature level has been reached, then the refrigerant is driven to flow through the main evaporator 20 and the solidified phase change materials are used to pre-cool the drying air stream before entering the main evaporator 20 so that the phase change materials can melt to be ready for the next drying cycle. This improves the energy performance. Then the phase change materials heated by the air stream melt.

In practice, the drying air stream bypasses the additional evaporator 22 with the phase change materials during the transitory phase and flows through the phase change materials to be cooled during the steady state phase.

The drying air circuit 12 and the refrigerant circuit 10 may be switched simultaneously once the favourable conditions are reached. Further, the drying air circuit 12 may be switched after, i.e. with a certain delay relative to when, the switching of the refrigerant circuit has occurred.

According to a further embodiment, the switching option of the drying air stream circuit is not provided and the flow direction remains the same during all the working phases of the tumble dryer, so that the air stream passes through the condenser 16 and the main evaporator 20 during the transitory phase and steady state phase. The ambient air heats up the phase change materials, which can melt again to be ready for the next drying cycle. Preferably, the ambient air is heated up by operational devices of the tumble dryer, which release waste heat, such as the motor for driving the laundry drum 24, the fan 26 and/or the additional fan 28.

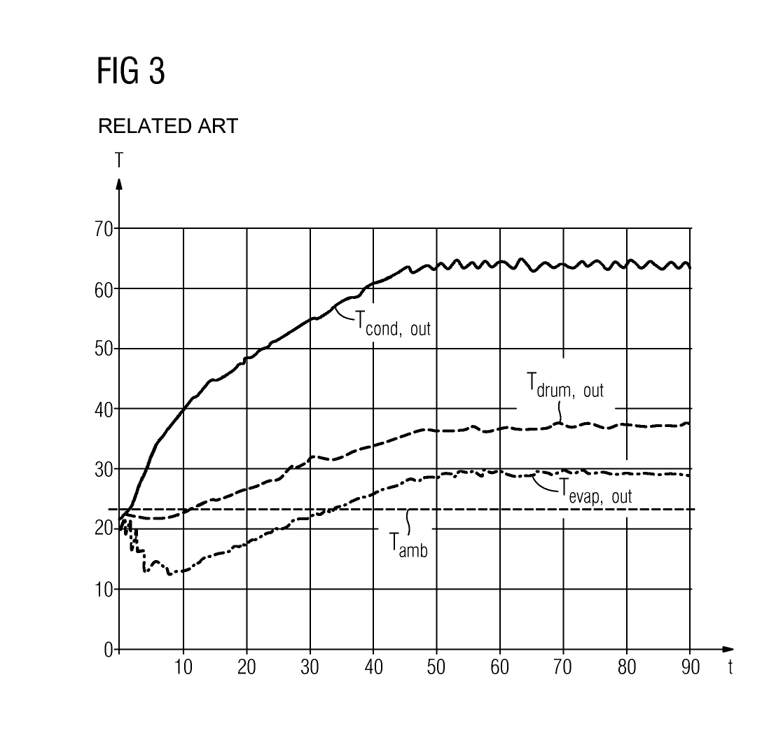

FIG. 3 shows a schematic diagram of temperatures T at some checkpoints of a conventional heat pump system for the tumble dryer as a function of time t.

In FIG. 3 the temperature T_{cond,out} of the air stream at the output of the condenser, the temperature T_{drum,out} of the air stream at the output of the laundry drum and the temperature T_{evap,out} of the air stream at the output of the evaporator are shown. Moreover, and the ambient temperature T_{amb} is also shown. FIG. 3 clarifies the behaviour of the temperatures during the transitory phase and the steady state phase. During the steady state phase the above temperatures remain substantially constant.

The present invention allows a faster increase of the temperatures during the transitory phase, so that the transitory phase is shortened.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 refrigerant circuit
12 air stream circuit
14 compressor
16 condenser
18 expansion device
20 main evaporator
22 additional evaporator
24 laundry drum
26 fan
28 additional fan
30 first three-way valve
32 second three-way valve
34 first baffle device
36 second baffle device
T temperature
t time
T_{cond,out} temperature at the output of the condenser
T_{drum,out} temperature at the output of the laundry drum
T_{evap,out} temperature at the output of the evaporator
T_{amb} ambient temperature

1. A laundry dryer with a heat pump system, said heat pump system comprising a closed refrigerant circuit and a drying air circuit, wherein:
the refrigerant circuit includes a compressor, a first heat exchanger, a second heat exchanger, and an expansion device,
the drying air circuit includes the first heat exchanger, the second heat exchanger, a laundry chamber and at least one fan,
the refrigerant circuit and the drying air circuit are thermally coupled by the first heat exchanger and the second heat exchanger,
the first heat exchanger is provided for cooling down the drying air and heating up the refrigerant,
the second heat exchanger is provided for heating up the drying air and cooling down the refrigerant, and
the refrigerant circuit includes at least one additional heat exchanger arranged in parallel to the first heat exchanger, wherein the additional heat exchanger is selectively connectable to the refrigerant circuit via valves means, so that the refrigerant can flow through either the first heat exchanger or the additional heat exchanger.

2. The laundry dryer according to claim 1, wherein the valve means comprise at least two three-way valves or at least two pairs of on-off valves.

3. The laundry dryer according to claim 1, wherein the refrigerant circuit and ambient air are thermally coupled by said additional heat exchanger.

4. The laundry dryer according to claim 1, further comprising an additional fan for moving the ambient air past the additional heat exchanger for heat exchange therewith.

5. The laundry dryer according to claim 1, wherein at least a part of said additional heat exchanger is embedded in phase changes materials, and the refrigerant circuit and the phase change materials are thermally coupled by the additional evaporator.

6. The laundry dryer according to claim 5, wherein the phase changing temperatures of the phase changes materials are between 10° C. and 30° C.

7. The laundry dryer according to claim 1, wherein the additional heat exchanger can be thermally coupled to the drying air circuit at least during one operational stage of the laundry dryer so that the drying air can exchange heat with the additional heat exchanger during said operational stage and wherein during said operational stage, the refrigerant flows through the first heat exchanger and the additional heat exchanger pre-cools the drying air before entering the first heat exchanger.

8. The laundry dryer according to claim 7, wherein the drying air circuit comprises at least one baffle device, operable so that the drying air either flows through the additional heat exchanger or bypasses the additional heat exchanger.

9. The laundry dryer according to claim 1, wherein a control unit is provided to actuate the valve means in response to at least one of the following:
temperatures of the drying air stream and/or time progressions of said temperatures,
temperature and/or pressure of the refrigerant and/or the time progressions of same, and
temperatures at the inlet and/or the outlet of the laundry chamber.

10. The laundry dryer according to claim 9, wherein the control unit actuates the valve means in response to temperatures and/or pressures of the refrigerant at the inlets and/or outlets of the second heat exchanger.

11. The laundry dryer according to claim 9, wherein the control unit actuates the valve means in response to temperatures and/or pressures of the refrigerant at the inlets and/or outlets of the compressor.

12. The laundry dryer according to claim 1, wherein a control unit is provided to actuate the valve means in response to passage of a predetermined time interval.

13. A method for operating a laundry dryer with a heat pump system, wherein the heat pump system comprises a closed refrigerant circuit and a drying air circuit, wherein:
the refrigerant circuit includes a compressor, a first heat exchanger, a second heat exchanger, and an expansion device,
the drying air circuit includes the first heat exchanger evaporator, the second heat exchanger, a laundry chamber and at least one fan,
the refrigerant circuit and the drying air circuit are thermally coupled by the first heat exchanger evaporator and the second heat exchanger,
the first heat exchanger is provided for cooling down the drying air and heating up the refrigerant,
the second heat exchanger is provided for heating up the drying air and cooling down the refrigerant, and
the heat pump system comprises an additional heat exchanger;
said method comprising the step of selectively switching the refrigerant circuit between a first mode in which the refrigerant by-passes the first heat exchanger and flows through the additional heat exchanger, and a second mode in which the refrigerant by-passes the additional heat exchanger and flows through the first heat exchanger.

14. The method according to claim 13, wherein the first mode occurs during a first operational stage of the laundry dryer starting when the compressor is switched on.

15. The method according to claim 13, wherein during the first mode the refrigerant is heated up in the additional heat exchanger by ambient air.

16. The method according to claim 13, wherein during the first mode the refrigerant is heated up in the additional heat exchanger by phase changes materials.
